(19) United States
(12) Patent Application Publication
(10) Pub. No.: US 2004/0137932 A1
(43) Pub. Date: Jul. 15, 2004

(54) Method for setting specific rate matching attributes for each services in a radiocommunications system

(76) Inventor: Pascal Agin, Sucy En Brie (FR)

Correspondence Address: SUGHRUE MION, PLLC, 2100 PENNSYLVANIA AVENUE, N.W., SUITE 800, WASHINGTON, DC, 20037, US

(21) Appl. No.: 10/477,583

(22) PCT Filed: May 13, 2002
(86) PCT No.: PCT/FR02/01598

(30) Foreign Application Priority Data
May 14, 2001 (FR) 01/060308

(51) Int. Cl. H04B 7/00

(52) U.S. Cl. 455/522

(57) ABSTRACT

One aspect of the invention consists in a method of adjusting a target transmission quality for transmit power control in a mobile radio system, in which method, a target transmission quality being taken as a reference common to different services for said transmit power control, said adjustment is such that said target transmission quality is increased until the target quality of service required for each service is achieved.

The present invention relates generally to mobile radio systems.

Generally speaking, advances in technology have given rise to two different types of systems, namely second generation systems, such as the Global System for Mobile communications (GSM) in particular, and third generation systems, such as the Universal Mobile Telecommunication System (UMTS) in particular.

Unlike second generation systems, which are optimized for only one type of service, in this instance voice, third generation systems are very suitable for providing multimedia services, for example simultaneous voice and Internet.

In third generation systems such as the UMTS in particular, different transport channels (TrCH) are generally defined for different services, which enables them to be differentiated in terms of quality of service, priority, etc.

In accordance with the layered organization generally used to describe these systems, in order to transmit them over the radio interface, the transport channels are processed in a layer called the physical layer, in which each TrCH is processed in accordance with a coding scheme that is specific to it (which scheme includes in particular channel coding and interleaving), after which the TrCHs processed in this way are time division multiplexed to form a coded composite transport channel (CCTrCH). Before it is transmitted at a particular power on one or more physical channels, the CCTrCH is processed, the processing including interleaving and transmission formatting on the physical channel or channels. For more information on these aspects of the UMTS, see in particular 3GPP Technical Specification TS 25.212.

In this instance, in a system such as the UMTS, all the bits (for all the services) transmitted on the same physical channel are transmitted at the same transmit power. Because of the interleaving, it is not possible to distinguish the bits of each service on the physical channel.

However, different services may require different qualities of service. For example, the required bit error rate (BER) for voice is typically 10⁻³, whereas the required error rate for data is much lower, typically 10⁻⁶.

One option would be to set the transmit power to a value sufficient for the target quality of service to be achieved for all services. However, this is not the optimum solution because power would then be wasted in the case of services requiring a lower quality of service.

For this reason the 3GPP standard provides another option, consisting in bit rate adaptation specific to each service, in addition to the bit rate adaptation effected to adapt the bit rate to be transmitted to the bit rate offered for its transmission. Bit rate adaptation is obtained by means of techniques such as repetition and/or puncturing, the rate of bit rate adaptation then being defined as the repetition and/or puncturing rate.

According to the 3GPP standard, each transport channel can have a specific parameter known as the rate-matching attribute (RM), which is an integer with values from 1 to 256 and is used to set the bit rate adaptation parameters simultaneously for all the transport channels in the physical layer and to obtain a higher energy per bit for one transport channel than for another, using a greater value of this parameter for a transport channel that requires a higher quality of service. For more information on these aspects of the UMTS, see 3GPP Technical Specifications TS 25.212 and TS 25.331.

This being the theory, a problem arises in practice in determining the values to be used for the bit rate adaptation parameters specific to each service.

One option would be to determine these values by simulation, trying all possible values and choosing from them those achieving the target quality of service for each service, for all possible combinations of services. However, a solution of this kind has the drawback that it takes a long time and requires a large memory volume to store all the data obtained in this way.

Another option is disclosed in the document WO 00/62465, which indicates that one of the transport channels (for example the transport channel that transports dedicated signaling) is selected as a reference transport channel, and a bit rate adaptation offset of each transport channel relative to the reference channel is determined. That document also indicates that the bit rate adaptation offsets could be representations of required quality differences between transport channels, and that the required quality differences could be represented by differences in the ratio of target energy per bit to noise E_{b}/N₀ without specific adaptation of the transport channel bit rate.

However, the above document provides no effective solution for determining the values to be used for these bit rate adaptation parameters specific to each service.

One object of the present invention is to provide an effective solution for setting these parameters, which in particular obtains optimum values for these parameters whilst being simple to put into practice and not costly in terms of the necessary time and memory volume.

Another option is mentioned in the document WO 99/53628, which indicates that the above kind of bit rate adaptation specific to each service can be controlled as a function of a signal received from the receiver.

However, the document provides no teaching as to how to implement such control and provides no solution for setting in this way the bit rate adaptation parameters specific to each service.

Another object of the present invention is to propose different solutions for such control, in particular for setting such parameters optimally.

Another object of the present invention is to provide such control in conjunction with the power control effected elsewhere in such systems.

A power control technique routinely used in these systems is the closed loop power control technique.

The object of closed loop power control is, for each connection between a base station and a mobile station, to maintain a parameter representative of the transmission quality on the connection (such as the signal to interface ratio SIR, for example) as close as possible to a target value. For example, in the uplink direction (from the mobile station to the base station), the base station periodically estimates the SIR and compares the estimated SIR to the target SIR. If the estimated SIR is below the target SIR, the base station requests the mobile station to increase its transmit power. On the contrary, if the estimated SIR is above the target-SIR, the base station requests the mobile station to reduce its transmit power.

The target SIR is generally chosen as a function of the required quality of service, and is routinely adjusted by an external loop algorithm (as compared to the previous algorithm, which is an internal loop algorithm). The principle of the external loop algorithm is to estimate the quality of service regularly and to compare the estimated quality of service to the required quality of service. The quality of service is generally represented by a bit error rate (BER), a frame error rate (FER), or a block error rate (BLER). If the estimated quality of service is below the required quality of service, the target SIR is increased; if not, the target SIR is reduced.

In one aspect the present invention consists in a method of setting bit rate adaptation parameters specific to each service in a mobile radio system, in which method said parameters are essentially fixed relative to each other approximately in proportion to corresponding target values of the energy per bit to noise ratio E_{b}/N₀, the target value of the ratio E_{b}/N₀ for a given service corresponding to the ratio necessary to achieve the target quality of service required for that service.

According to another feature, said target values of the ratio E_{b}/N₀ are estimated values.

According to another feature, said parameters are set in the above manner on each new initialization of at least one service.

According to another feature, a reference parameter value is set for one of said services.

According to another feature, said reference service is that having the highest target value of the ratio E_{b}/N₀.

According to another feature, said reference parameter value corresponds to a maximum value for said parameters.

In another aspect the present invention consists in a method of fixing bit rate adaptation parameters specific to each service in a mobile radio system, the method being essentially such that said parameters are adjusted dynamically to minimize the transmit power for achieving the target quality of service required for each service.

According to another feature, transmit power control is provided, and a target transmission quality, taken as a reference for said transmit power control common to said services, is adjusted dynamically so that a reference target quality of service is achieved in all cases.

According to another feature, said transmission quality is represented by the signal to interference ratio (SIR).

According to another feature, said reference target quality of service corresponds to the target quality of service required for one of the services referred to as the reference service.

According to another feature, said reference service is that which requires the greatest energy per bit transmitted.

According to another feature, said reference target quality of service corresponds to a target quality of service sufficient to achieve the target quality of service required for all the services.

According to another feature, a reference parameter value is associated with said reference target quality of service.

According to another feature, said reference parameter value corresponds to the maximum value for said parameters.

According to another feature, said parameters are adjusted only if the reference quality of service is sufficiently close to the reference target quality of service.

According to another feature, said reference target quality of service corresponding to the target quality of service required for one of the services, called the reference service, said target transmission quality adjustment is such that said target transmission quality is increased until the target service quality required for said reference service is achieved.

According to another feature, said reference target quality of service corresponding to the target quality of service required for one of the services, called the reference service, said target transmission quality adjustment is further such that said target transmission quality is reduced for as long as the quality of service required for said reference service is achieved.

According to another feature, said reference target quality of service corresponding to a target quality of service sufficient to achieve the required target quality of service for all the services, said target transmission quality adjustment is such that said target transmission quality is increased until said target quality of service sufficient for all the services is achieved.

According to another feature, said reference target quality of service corresponding to a quality of service sufficient to achieve the required quality of service for all the services, said target transmission quality adjustment is further such that said target transmission quality is reduced for as long as said target quality of service sufficient for all the services is achieved.

According to another feature, said parameters are adjusted only if the estimated transmission quality is sufficiently close to the target transmission quality.

According to another feature, each of said parameters is adjusted dynamically, as a function of a corresponding quality of service indicator.

According to another feature, some of said parameters, known as first parameters, are adjusted dynamically, as a function of corresponding quality of service indicators, and the other parameters, known as second parameters, are set as a function of the first parameters adjusted in this way.

According to another feature, said second parameters are set so as to maintain approximately constant the ratio RMᵢ/RM₀, where RMᵢ is a second parameter and RM₀ is a reference parameter.

According to another feature, the ratio RMᵢ/RM₀ is set approximately in proportion to corresponding target values of the ratio E_{b}/N₀, the target value of the ratio E_{b}/N₀ corresponding to the energy per bit to noise ratio necessary to achieve the corresponding required target quality of service.

According to another feature, said reference parameter corresponds to one of said first parameters.

In a further aspect the present invention consists in a method of adjusting a target transmission quality for transmit power control in a mobile radio system, said method being essentially such that, a target transmission quality being taken as a reference common to different services for said transmit power control, said adjustment is such that said target transmission quality is increased until the target quality of service required for each service is achieved.

According to another feature, said adjustment is further such that said target transmission quality is reduced immediately the required target quality of service is achieved for at least one of the services.

The present invention also consists in:

a mobile station (in particular a user equipment (UE) in a system such as the UMTS),

a mobile radio network equipment (in particular a base station such as a Node B in a system such as the UMTS or a base station controller such as a radio network controller (RNC) in a system such as the UMTS),

a mobile radio network, and

a mobile radio system,

all including means for implementing the above methods individually or in combination.

Other aspects and features of the present invention will become apparent on reading the following description of embodiments of the invention, which is given with reference to the appended drawings, in which:

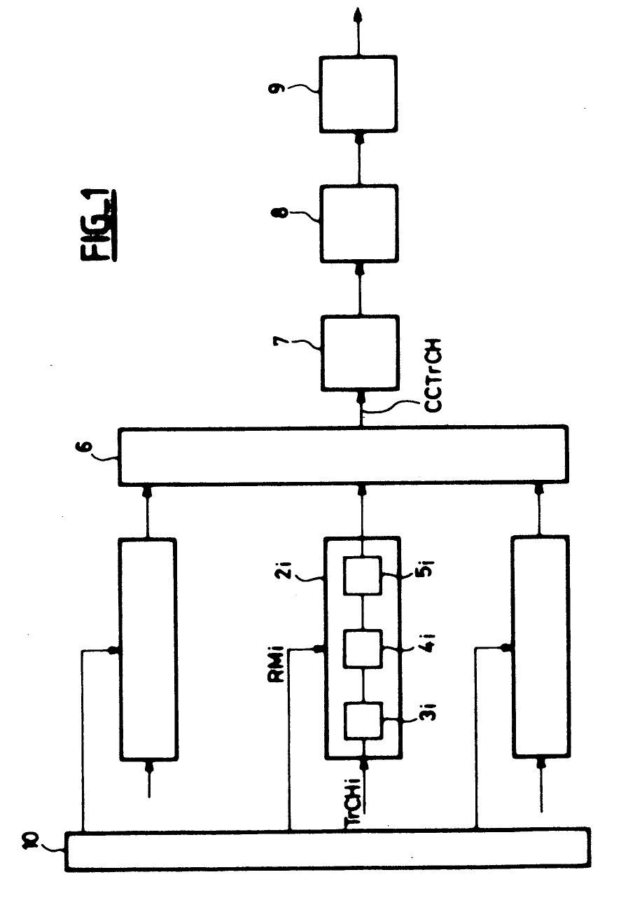

FIG. 1 shows one embodiment of a mobile radio system transmitter using a first method of the invention, and

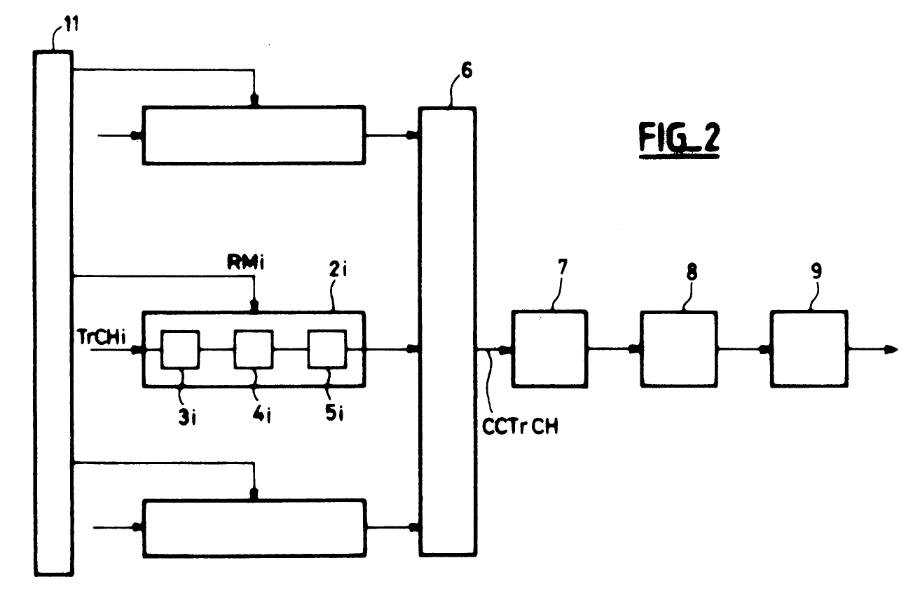

FIG. 2 shows one embodiment of a mobile radio system transmitter using a second method of the invention.

One feature of a system such as the UMTS is the possibility of transporting a plurality of services on the same connection. The services are distinguished by means of transport channels (TrCH). The transport channels are processed separately in accordance with a channel coding scheme (including error detector coding, error corrector coding, bit rate adaptation, and interleaving) before being time division multiplexed to form a coded composite transport channel (CCTrCH) to be transmitted on one or more physical channels. More information on these aspects of the UMTS can be found in 3G Technical Specification TS 25.212 published by the 3GPP.

The structure of a corresponding transmitter is outlined in FIGS. 1 and 2, and essentially comprises:

for each transport channel TrCHi (with i=1 to N, where N is the number of services, or transport channels, that are multiplexed to form a CCTrCH), channel coding means 2i in turn including error corrector coding means 3i, bit rate adaptation means 4i, and interleaving means 5i,

means 6 for multiplexing different transport channels TrCHi processed in this way by the various channel coding means 2i to produce a coded composite transport channel CCTrCH,

means 7 for processing the coded composite transport channel CCTrCH obtained in this way,

spectrum spreading and modulation means 8, and

radio frequency transmission means 9.

Although not specifically shown, the structure of a receiver is deduced from that of the transmitter by providing, in the reverse order, means for implementing functions that are the converse of those implemented by the transmitter. Bit rate adaptation parameters set in accordance with the invention can be used both for sending and for receiving.

As indicated in the introduction, each transport channel TrCHi can have a specific bit rate adaptation parameter known as the rate matching attribute RMᵢ which is a parameter of the bit rate adaptation process that is applied to all the transport channels simultaneously in the physical layer. This parameter provides a greater energy per bit for one transport channel than for another, using a greater value of this parameter for a transport channel that requires a higher quality of service.

The present invention proposes various approaches to setting bit rate adaptation parameters specific to each service.

Thus the present invention proposes a first approach whereby said parameters are set relative to each other, approximately in proportion to the corresponding target values of the ratio E_{b}/N₀, the target value of the ratio E_{b}/N₀ for a given service corresponding to the energy per bit to noise ratio necessary to achieve the corresponding target quality of service required for the service.

In other words, the invention suggests deriving optimum values of the bit rate adaptation parameters specific to each service for all combinations of services as a function of the target ratio E_{b}/N₀ for each service. Thus new values are set for these various parameters on each initialization of a new service. Otherwise, the parameters remain unchanged.

In other words, the invention suggests determining the parameters RMᵢ so that the ratio RMᵢ/RMⱼ is approximately equal to the ratio (E_{b}/N₀)ᵢ/(E_{b}/N₀)ⱼ for all service pairs (i, j).

(E_{b}/N₀)ᵢ is the target mean energy per bit transmitted to noise ratio E_{b}/N₀ for the i^{th} service (with i=1 to N) necessary to achieve the quality of service required for the i^{th} service. It is measured at the receiving end and expressed in linear units. It can be measured using conventional techniques that do not need to be described again here.

The target values of the ratio E_{b}/N₀ for the various services concerned can be estimated for each of the services in isolation.

These target values of the ratio E_{b}/N₀ can be estimated under various conditions:

by simulation,

by measurement under real life conditions,

etc.

Thus FIG. 1 shows means 10 for supplying parameters RMᵢ set relative to each other substantially in proportion to corresponding target values of the ratio E_{b}/N₀.

A reference parameter value RM₀ can be set for one of the services. For example, a reference transport channel TrCH₀ can be chosen and the corresponding value RM₀ set arbitrarily. For example, the reference transport channel TrCH₀ chosen can be the TrCH having the highest target value of the ratio E_{b}/N₀, and the value RM₀ can then be chosen as equal to 256, for example (this is the maximum value in the UMTS, for example). Each RMᵢ is then chosen so that the ratio RMᵢ/RM₀ is approximately equal to the ratio (E_{b}/N₀)ᵢ/(E_{b}/N₀)ⱼ. This is sufficient to ensure that the ratio RMᵢ/RMⱼ is approximately equal to the ratio (E_{b}/N₀)ᵢ/(E_{b}/N₀)ⱼ for all service pairs (i, j).

According to the 3GPP standard, the parameters RMᵢ and RMⱼ are integers that can take any value from 1 to 256. There is therefore a limit on the number of values of the ratio RMᵢ/RMⱼ. For this reason in particular, the following equation:

$$\frac{{RM}_{i}}{{RM}_{j}} = \frac{{( {E}_{b} / {N}_{0} )}_{i}}{{( {E}_{b} / {N}_{0} )}_{j}}$$

cannot be satisfied exactly, only approximately, and the parameters RMᵢ and RMⱼ must be chosen so that the ratio RMᵢ/RMⱼ is as close as possible to the ratio (E_{b}/N₀)ᵢ/(E_{b}/N₀)ⱼ, or the greatest (respectively the smallest) integer value below (respectively above) the ratio (E_{b}/N₀)ᵢ/(E_{b}/N₀)ⱼ.

In theory, this way of setting the bit rate adaptation parameters specific to each service achieves the target quality of service for all the transport channels simultaneously; in other words there exists a power P such that, when the power is greater than P, the quality of service QoS is achieved for all services and when the power is less than P the quality of service QoS is not achieved for any service.

In practice, the quality of service QoS will probably not be achieved at exactly the same time for all the services, since the target value of the ratio E_{b}/N₀ must be estimated, but all the QoS will be achieved at a power that is significantly lower than would be the case if the bit rate adaptation parameters had not been optimized in this way.

One problem with the previous approach is that the ratio E_{b}/N₀ is greatly dependent on factors such as environment and speed. However, these variations are usually minor, so that an average value could be used, for example, or the greatest of the target values of the ratio E_{b}/N₀, considering a plurality of environments and speeds, to adopt a more conservative approach.

Thus a second approach, which can be considered as an alternative to the previous approach, dynamically adapts the bit rate adaptation parameters specific to each service (or transport channel) so that the quality of service of each transport channel is as close as possible to the respective quality of service. The advantage of an approach of this kind is that there is no need to estimate the target value of the ratio E_{b}/N₀ and to adapt the bit rate adaptation parameters specific to each service dynamically to suit changes of environment, speed, etc.

Thus the present invention proposes a second approach, whereby said parameters are adjusted dynamically to minimize the transmit power achieving the target quality of service required for each service.

In other words, the present invention teaches dynamically adapting the bit rate adaptation parameters specific to each service as a function of the quality estimated at the receiving end, in a similar manner to the external power control loop.

Thus FIG. 2 shows means 11 for supplying parameters RMᵢ that are adjusted dynamically to minimize (or at least greatly to reduce) the transmit power achieving the target quality of service required for each service.

Furthermore, a target transmission quality taken as a transmit power control reference common to said services can be adjusted dynamically so that a reference target quality of service is achieved in all cases. Transmission quality is represented in particular by the signal to interference ratio (SIR).

In a first embodiment, said reference target quality of service corresponds to the target quality of service required for one of the services referred to as the reference service.

Said reference service is advantageously that which requires the greatest energy per bit transmitted.

In a second embodiment, said reference target quality of service corresponds to a target quality of service sufficient to achieve the required target quality of service for all the services.

The first embodiment (as previously defined, i.e. for which the reference target quality of service corresponds to the target quality of service required for a reference service) can then be described in the following manner, for example.

Let Qᵢ denote the value of a quality of service indicator for the i^{th} transport channel and let (Qᵢ)_{target} denote the target value of that indicator (the sign of Qᵢ is chosen so that if Qᵢ<(Qᵢ)_{target} the quality of service is lower than the target quality of service, i.e. the power must be increased). The quality of service indicators (such as BER, BLER, raw BER, SIR, etc.) of the various transport channels are identical, although they can be different.

The method includes the following steps, for example:

The external power control loop is executed on a reference transport channel, for example the first transport channel (TrCH₀). Any algorithm can be used whose object is to make Q₀ as close as possible to (Q₀)_{target}.

It is periodically verified whether Qᵢ is close to (Qᵢ)_{target} for the other transport channels (i>0). The period can be different from that of the external loop algorithm.

If Qᵢ−(Qᵢ)_{target}<ηᵢ, the ratio RMᵢ/RM₀ is increased.

If Qᵢ−(Qᵢ)_{target}>η′ᵢ, the ratio RMᵢ/RM₀ is reduced.

ηᵢ and η′ᵢ are parameters of the algorithm whose object is to prevent the bit rate adaptation parameters from being changed too frequently. Usually, ηᵢ≦0 and η′ᵢ≧0.

The ratio RMᵢ/RM₀ can be increased or reduced by changing one or more of the parameters RMᵢ with i≧0. Any rule can be used for changing them: for example, they can be increased or reduced by a particular multiplication factor α which is a parameter of the algorithm.

Alternatively, the ratio RMᵢ/RM₀ could be modified only when Q₀ is close to (Q₀)_{target} and/or when the estimated transmission quality (SIR) is close to the target transmission quality (SIR_{target}). In other words, the ratio RMᵢ/RM₀ could be modified only when:

|Q₀−(Q₀)_{target}|<s

and/or

|SIR−SIR_{target}|<s′

where s and s′ are parameters of the algorithm.

A good solution is for the reference transport channel to be the transport channel that requires the greatest energy per bit transmitted, so that when the quality of service is achieved for that transport channel, the quality of service is also achieved for the other transport channels (at least when all the RMᵢ are equal). In this case, the bit rate adaptation parameter of the transport channel can be made equal to the maximum value (256 in the UMTS), since it must be greater than all the other bit rate adaptation parameters.

An advantage of this solution is that at call initialization, when all the RMᵢ are set to a default value (usually the same value), when the quality of service of this transport channel is achieved, it is achieved for all the transport channels.

Accordingly, in this first embodiment, the adjustment of said target transmission quality is such that the target transmission quality is increased until the required target quality of service for the reference service is achieved.

Said target transmission quality adjustment is further such that the target transmission quality is reduced as long as the service quality required for said reference service is achieved.

Accordingly, in this first embodiment, the means 11 in FIG. 2 can include means for implementing the algorithm as described above, or at least, if a portion of the algorithm is implemented in the transmitter and another portion in the receiver, as in the case of the transmitter shown in FIG. 2, the portion of the algorithm that is implemented in the transmitter.

The second embodiment (as previously defined, i.e. for which the reference target quality of service corresponds to a target quality of service sufficient to achieve the target quality of service required for all the services) can then be described in the following manner, for example.

Instead of being executed on a dedicated transport channel, the power control external loop is executed considering all the transport channels, for example with an algorithm such as the following:

If Qᵢ−(Qᵢ)_{target}<ηᵢ for all values of i, the target SIR is increased (for example with a particular step d_{UP}).

If Qᵢ−(Qᵢ)_{target}>ηᵢ for one value of i, the target SIR is decreased (for example with a particular step d_{DOWN}).

Otherwise, the target SIR is unchanged.

ηᵢ and η′ᵢ are parameters of the algorithm whose object is to prevent the target SIR from being changed too frequently. Usually, ηᵢ≦0 and η′ᵢ≧0.

Accordingly, in this second embodiment, the target transmission quality adjustment is such that this target transmission quality is increased until the target quality of service sufficient for all the services is achieved.

Said target transmission quality adjustment is also such that the target transmission quality is decreased as long as the target quality of service sufficient for all the services is achieved.

Similarly, in this second embodiment, the means 11 in FIG. 2 can include means for implementing the algorithm obtained in this way, or at least, if one portion of the algorithm is implemented in the transmitter and another portion in the receiver, as in the case of the transmitter shown in FIG. 2, the portion of the algorithm that is implemented in the transmitter.

The idea of this kind of power control external loop algorithm is that the target SIR is increased until the target quality of service (QoS) is achieved for all the transport channels.

Furthermore, the target SIR can be reduced as soon as the target quality of service is achieved for at least one of the transport channels.

The advantage of this kind of solution is that it requires no knowledge or estimate of the transport channel that requires the highest energy per bit transmitted.

Another object of the present invention is to provide a power control external loop based on the above kind of principle.

In other words, the present invention further consists in a method of adjusting a target transmission quality for transmit power control in a mobile radio system, said method being essentially such that, a target transmission quality being taken as a transmit power control reference common to different services, said adjustment is such that said target transmission quality is increased until the quality of service required for each service is achieved.

Furthermore, in the example described, said target transmission quality is decreased as soon as the quality of service required for at least one of the services is achieved.

In the foregoing description, the terms “service” and “transport channel” are used interchangeably. Note, however, that it is possible for the same service to use different transport channels. For example, for speech using adaptive multirate (AMR) coding, three different transport channels are generally used: one for bits of class A, one for bits of class B, and one for bits of class C, where the three classes of bits correspond to different levels of importance of the bits. Note also that it is possible for no quality of service to be indicated for a given transport channel. In the AMR situation, for example, it is generally attempted to achieve a bit error rate (BER) of 10⁻³ for the TrCH carrying the bits of class A only. However, even in cases where no quality of service is imposed, a quality of service can be set more or less arbitrarily.

To encompass these various possibilities, the term “service” is used in the sense where, as a general rule, a particular target quality of service must be achieved for a particular transport channel, independently of how the services and the transport channels are defined.

Furthermore, an application example that is important in practice corresponds to the situation in which there are simultaneously operative a connection using AMR coding and a packet mode connection (in particular a packet mode connection at 384 kbit/s). In this case five transport channels or dedicated channels (DCH) can be used, for example: three for the various AMR bit classes, one for the packet connection, and an additional channel (usually used for signaling). In this case, a quality of service indicator (such as the BLER in particular) can be estimated only for the TrCH carrying the bits of AMR class A and for the TrCH used for the packet mode connection (and thus for only two of the four TrCHs). In this case, if an algorithm such as that described above is used to adjust the RM parameters dynamically, the algorithm applies only to TrCHs for which the quality of service indicator can be estimated. Then only the RM parameters of the two TrCHs (or first RM parameters) are modified. To set the RM parameters of the other two TrCHs (or second RM parameters), corresponding in this instance to the bits of AMR classes B and C, one of the following methods can be used, for example:

the first parameters are set,

the second parameters are set as a function of the first parameters, so as to maintain more or less constant the ratio RMᵢ/RM₀, where RMᵢ is a second parameter and RM₀ is a reference parameter, corresponding for example to the TrCH carrying the bits of AMR class A; for example, the value of RMᵢ/RM₀ can be set statically, for example using the ratio E_{b}/N₀ as described in connection with the first method of the invention.

To encompass these various possibilities, in the context of the invention the concept of reference parameters is widened to cover equally the situation in which the reference parameter is the same for all the services, as when the reference parameter is not the same for all the services, and corresponds for example to a TrCH belonging to the same service as the parameter that is to be set with reference to the reference parameter.

The present invention also consists in:

a mobile station (in particular a user equipment (UE) in a system such as the UMTS),

a mobile radio network equipment (in particular a base station such as a Node B or a base station controller such as a radio network controller (RNC) in a system such as the UMTS),

a mobile radio network, and

a mobile radio system,

all including means for implementing the above methods individually or in combination.

The above means can use either of the methods previously described; their particular implementation presenting no particular problem for the person skilled in the art, such means need not be described here in more detail than by stating their function.

1. A method of adjusting a target transmission quality for transmit power control in a mobile radio system, in which method, a target transmission quality being taken as a reference common to different services for said transmit power control, said adjustment is such that said target transmission quality is increased until the target quality of service required for each service is achieved.

2. A method according to claim 2, in which said adjustment is further such that said target transmission quality is reduced immediately the required target quality of service is achieved for at least one of the services.

3. A mobile station including means for implementing a method according to claim 1 or claim 2.

4. A mobile radio network equipment including means for implementing a method according to claim 1 or claim 2.

5. A mobile radio system including means for implementing a method according to claim 1 or claim 2.
